(19) United States
(12) Patent Application Publication
(10) Pub. No.: US 2022/0207918 A1
(43) Pub. Date: Jun. 30, 2022

(54) INFORMATION OBTAIN METHOD, INFORMATION PUSH METHOD, AND TERMINAL DEVICE

(71) Applicant: HONDA MOTOR CO., LTD., Tokyo (JP)

(72) Inventors: Nobuaki Asahara, Guangzhou (CN); Pengcheng Qian, Guangzhou (CN); Zhong Liu, Guangzhou (CN)

(21) Appl. No.: 17/562,048

(22) Filed: Dec. 27, 2021

(30) Foreign Application Priority Data
Dec. 30, 2020 (CN) 202011616647.9

(51) Int. Cl. G06V 40/16; G10L 25/63; G06V 40/20; G06T 11/00; G06V 20/59

(52) U.S. Cl. CPC G06V 40/176; G10L 25/63; G06V 20/597; G06T 11/00; G06V 40/20

(57) ABSTRACT

An information obtain method includes a step of obtaining a current smile level of a user and a real-time information, the real-time information including a state information of the user and/or a scene information of a scene in which the user is; and a step of obtaining a service information when the smile level of the user reaches a predetermined level, the service information matching at least one of the state information and the scene information while the service information being able to improve the current smile level of the user.

### CROSS-REFERENCE TO RELATED APPLICATION

The priority is claimed based on a Chinese Patent Application No. 202011616647.9, filed on Dec. 30, 2020. The content of the Chinese Patent Application is incorporated herein by reference.

### TECHNICAL FIELD

The present disclosure relates to a technical field of information technology. Particularly, the present disclosure realates to an information obtain method, an information push method, and a terminal device.

### BACKGROUND ART

With the development of the internet technology and the information technology, various of terminal devices are broadly utilized and the functions of the terminal devices become more and more fulfilling.

One of the main functions of the terminal device is to receive services via the terminal devices. For example, with regard to a mobile terminal device, a user can receive the multimedia playback services such as the Internet service, the music playback service, the video playback service, the radio broadcast service and the like via the mobile terminal device. With regard to an in-vehicle terminal device, a user of the vehicle can receive both the multimedia playback services such as the internet service, the music playback service, the video playback service, the radio broadcast service and the like and the navigation service via the in-vehicle terminal device.

Recently, the information push technology has been rapidly developed and during the period when the user uses the terminal device, the terminal device can push various service information such as the multimedia information, the product information and the merchant information to the user. Here, there is conventional technology of pushing the information to the user corresponding to the information such as the mood of the user and the environment.

The disclosure of the above-mentioned background art is to make it convenient to clearly and completely explain the technical content of the present disclosure and is for the skilled person in the art to easily understand the content of the present disclosure. These explanations are not intended to indicate that the above technical content is a well-known technology to those skilled in the art.

### SUMMARY

According to the conventional technology of pushing the information based on the information of the mood of the user and the environment, it is possible that the user cannot receive the service information in a state in which it is possible for the user to receive the service or the user intends to receive the service information. For example, when the user is in a negative mood, it is possible for the user to refuse the push of the information so as to further aggravate the user's mood and reduce the user experience. Also, it is possible that the information pushed to the user cannot effectively improve the mood of the user so as to reduce the user experience.

The present disclosure is made in consideration of the above-identified circumstances to provide an information obtain method, an information push method, and a terminal device so as to push the service information to the user in a state in which the user is possible to receive the service information or the user intends to receive the service information by pushing the service information to the user when the current smile level of the user reaches a predetermined level and improve the user experience. Also, the service information pushed to the user may further improve the current smile level of the user and the service information matches the state information and/or the scene information such that it is possible to definitely push the information for increasing the happiness degree of the user while effectively improving the user experience.

According to a first aspect of the present disclosure, an information obtain method includes a step of obtaining a current smile level of a user and a real-time information, the real-time information including a state information of the user and/or a scene information of a scene in which the user is; and a step of obtaining a service information when the smile level of the user reaches a predetermined level, the service information matching at least one of the state information and the scene information while the service information being able to improve the current smile level of the user.

In the information obtain method according to a second aspect of the present disclosure, the service information being able to improve the currently smile level of the user may be information of a service corresponding to a higher smile level than the current smile level of the user.

In the information obtain method according to a third aspect of the present disclosure, the information obtain method may further include a step of obtaining an user information of the user, wherein the service information is able to improve the current smile level of the user while matching the user information and at least one of the state information and the scene information.

In the information obtain method according to a fourth aspect of the present disclosure, the state information may include at least one of a fatigue information, a biometric information, and an exercise information of the user, the scene information may include at least one of an environment information, a location information, a traffic information, and a weather information of an environment where the user is, and the user information may include at least one of an identification (ID) information, a hobby information, and an usage history information of the user.

In the information obtain method according to a fifth aspect of the present disclosure, the state information may include at least a first parameter indicating at least one of the fatigue information, the biometric information, and the exercise information of the user, the scene information may include at least a second parameter indicating at least one of the environment information, the location information, the traffic information, and the weather information of the environment where the user is, the user information may include at least a third parameter indicating at least one of the identification (ID) information, the hobby information, and the usage history information of the user, and each of the first parameter, the second parameter, and the third parameter may have a priority at the time of performing the matching for generating the service information.

The information obtain method according to a sixth aspect of the present disclosure may further include a step of obtaining at least one of an image information or a voice information of the user; and a step of determining the current smile level of the user based on at least one of the image information or the voice information of the user.

The information obtain method according to a seventh aspect of the present disclosure may further include a step of presenting the service information to the user by a display manner and/or a voice manner.

The information obtain method according to an eighth aspect of the present disclosure may further include a step of sending a bonus information to an account of the user when an operation based on the service information and/or a feedback from the user is received, and a step of generating a record information by associating the current smile level of the user, the state information and/or the scene information, and the service information, and sending the record information to a server.

The information obtain method according to a ninth aspect of the present disclosure may further include a step of sending a bonus information to an account of the user in a case in which the smile level of the user is detected to be improved after an operation based on the service information from the user is received, and a step of generating a record information by associating the current smile level of the user, the state information and/or the scene information, and the service information, and sending the record information to a server.

The information obtain method according to a tenth aspect of the present disclosure may further include a step of making a virtual character corresponding to the user to grow based on the bonus information.

In the information obtain method according to an eleventh aspect of the present disclosure, there may be at least two users, and the information obtain method may further include a step of generating and broadcasting a remind information with respect to the user having the higher smile level so as to encourage a share by the user in a case in which a difference between the smile levels of the at least two users reaches a predetermined value.

In the information obtain method according to a twelfth aspect of the present disclosure, there may be at least two users, and the information obtain method may further include a step of obtaining the service information in a case in which the current smile level of at least one of the two users reaches a predetermined level, the service information being able to improve the current smile level of at least one of the two users, and the service information matching at least one of the state information or the scene information of the at least one of the two users.

The information obtain method according to a thirteenth aspect of the present disclosure may further include a step of generating a record information by associating the current smile level of the at least two users, the state information and/or the scene information, and the service information, and sending the record information to a server in a case in which it is detected that both the smile levels of the at least two users are improved after the operation based on the service information from the at least one user is received.

The information obtain method according to a fourteenth aspect of the present disclosure may further include a step of generating a smile map information based on the smile level of the user and the scene information.

According to a fifteenth aspect of the present disclosure, an information push method includes a step of obtaining a current smile level of a user that reaches a predetermined level and a real-time information from a terminal device, the real-time information including a state information of the user and/or a scene information of a scene in which the user is; a step of generating a service information, the service information being able to improve the current smile level of the user while the service information matching at least one of the state information and the scene information; and a step of sending the service information to the terminal device.

The information push method according to a sixteenth aspect of the present disclosure may further include a step of updating a database for the matching to generate the service information based on a record information of the terminal device, wherein the record information is information generated by associating the current smile level of the user, the state information and/or the scene information, and the service information and stored.

In the information push method according to a seventeenth aspect of the present disclosure, the service information being able to improve the current smile level of the user may be information of a service corresponding to a higher smile level than the current smile level of the user.

According to an eighteenth aspect of the present disclosure, a terminal device includes a memory storing a computer-readable program; and a processor configured to implement the information obtain method according to claim 1 when the computer-readable program is executed by the processor.

In the terminal device according to a nineteenth aspect of the present disclosure, the terminal device may be an in-vehicle terminal, and the user may be the user driving the vehicle, and/or a user boarding on the vehicle.

### Advantageous Effects of Invention

According to the above-described aspects of the present disclosure, when the current smile level of the user reaches the predetermined level, it is possible to push the service information to the user in the state in which it is possible for the user to receive the service information or the user intends to receive the service information to improve the user experience. The service information being pushed to the user can improve the current smile level of the user while the service information matches with the state information and/or the scene information such that it is possible to increase the happiness degree of the user and definitely push the information for effectively improving the user experience to the user.

Furthermore, the service information being able to improve the current smile level of the user is the information of the service corresponding to the higher smile level than the current smile level of the user so as to make the matching of the services easy to be realized and guarantee the effectiveness for improving the smile level by the service that is achieved by the matching.

When the service information is generated, the matching is performed based on the user information so as to further improve the accuracy of the information push.

The state information, the scene information, and the user information used during the matching include a plurality of types of information so as to further improve the accuracy of the information push.

At the time of performing the matching to generate the service information, each of the first parameter of the state information, the second parameter of the scene information, and the third parameter of the user information has the priority such that it is possible to generate and push the effective information with the higher correspondence by the matching and make the information to fit with the current scene and the state.

It is possible to correctly determine the smile level of the user in real-time by determining the current smile level of the user based on at least one of the image information and the voice information of the user.

It is possible to push the information to the user flexibly by showing the service information to the user by the display manner and/or the voice manner.

Furthermore, by sending the bonus information to the account of the user when the operation and/or the feedback based on the service information is received from the user, it is possible to encourage the user to use or experience the service information so as to further improve the user experience. In this situation, by generating the record information and sending the record information to the server, it is possible to record the information with values and update the database for the matching so as to further improve the accuracy of the matching.

In the case in which the smile level of the user is detected to be improved after the operation based on the service information is received from the user, the bonus information is sent to the account of the user. Accordingly, it is possible to encourage the user to use or experience the service information so as to further improve the user experience. In this situation, by generating the record information and sending the record information to the server, it is possible to record the information with values for the later usage and update the database for the matching so as to further improve the accuracy of the matching.

By making the virtual character corresponding to the user to grow based on the bonus information, it is possible to build a firm correspondence relationship between the virtual character and the user. According to such a correspondence relationship, it is possible to encourage the user to smile for prompting the growth of the virtual character such that it is possible to keep the user in the positive mood and further improve the user experience.

The growth of the virtual character may include at least one of the image change of the virtual character, the increase of the movements of the virtual character, and the increase of the number of the virtual characters. The image change of the virtual character can enrich the visual experience of the user, the increase of the movements of the virtual character can increase the functions that can be used by the user, and the increase of the number of the virtual characters can significantly increase the fun of the user when using the devices so as to further improve the user experience.

In a case in which there are at least two virtual characters, there is a specific relationship between the at least two virtual characters and the at least two virtual characters perform the interaction corresponding to the specific relationship. Accordingly, it is possible to further increase the fun of using the virtual character and improve the user experience.

In a case in which it is detected that the difference between the smile levels of the at least two users reaches the predetermined value, by generating and broadcasting the remind information with respect to the user having the higher smile level, it is possible to share the information about mood improvement among multiple users and ease relationships between the users so as to further improve the user experience.

Furthermore, when the smile level of at least one of the two users reaches the predetermined value, it is possible to push information appropriately in the scene of multiple users by obtaining the service information.

In a case in which it is detected that both the smile levels of the at least two users are improved after the operation based on the service information from the at least one user is received, the record information is generated and sent to the server. Accordingly, in the scene in which there are multiple users, it is possible to record the information with values for the later usage and update the database for the matching so as to further improve the accuracy of the matching.

Furthermore, the service information being able to improve the current smile level of the user is the information of the service corresponding to the higher smile level than the current smile level of the user. Accordingly, it is possible to easily realize the matching of the services and ensure the effectiveness of the service obtained by the matching for improving the smile level. Furthermore, by generating the smile map information based on the smile level of the user and the scene information, it is possible to provide the information with enough fun to the user to further improve the user experience.

### BRIEF DESCRIPTION OF DRAWINGS

FIG. 1 is a schematic view showing an example of an information obtain method according to a first embodiment of the present disclosure.

FIG. 2 is a schematic view showing another example of an information obtain method according to a first embodiment of the present disclosure.

FIG. 3 is a schematic view showing a further example of an information obtain method according to a first embodiment of the present disclosure.

FIG. 4 is a schematic view showing an information push method according to a second embodiment of the present disclosure.

FIG. 5 is a schematic view showing an information push method according to a third embodiment of the present disclosure.

FIG. 6 is a schematic block diagram showing a system configuration of a terminal device according to a fourth embodiment of the present disclosure.

FIG. 7 is a schematic block diagram showing a system configuration of a server according to a fifth embodiment of the present disclosure.

FIG. 8 is a schematic view showing an information push system according to a sixth embodiment of the present disclosure.

### DESCRIPTION OF EMBODIMENTS

In order to make the technical problem, the solutions and the effects of the present application more clear, hereinafter, embodiments of the present application will be described with reference to the figures. Hereinafter, the following embodiments are only used to describe the present application and are not used to limit the present application. Also, the configurations shown in figures are only specific examples of the present application and the person with ordinary skill in the art can achieve other figures based on the enclosed figures of the present application.

The features disclosed and/or indicated in an embodiment can be included in another or multiple embodiments in the same or similar manner. Such features can be appropriately combined with the features disclosed in the other embodiment or replace the features described in other embodiments.

It should be emphasized that in the present description, the terms “include”, “have”, “possess” and the like are intended for describing the existence of the entire assembly or features, and the existence of components. However, the existence or addition of one or more than one features, assemblies, and components cannot be excluded.

In the following description, the features according to the present disclosure shown above and other features will be described. In the description and drawings, the specific embodiment of the present disclosure are disclosed, and it is possible to adopt the principle concept of the present disclosure in part of the embodiments. It should be understood that the scope of present disclosure is not limited to the embodiments shown below, and the inventions according to the enclosed claims and the equivalent configurations are included therein.

Hereinafter, an information obtain method and an information push method according to the embodiments of the present disclosure will be descripted.

### First Embodiment

The first embodiment of the present disclosure provides an information obtain method. The information obtain method is applied to a terminal device.

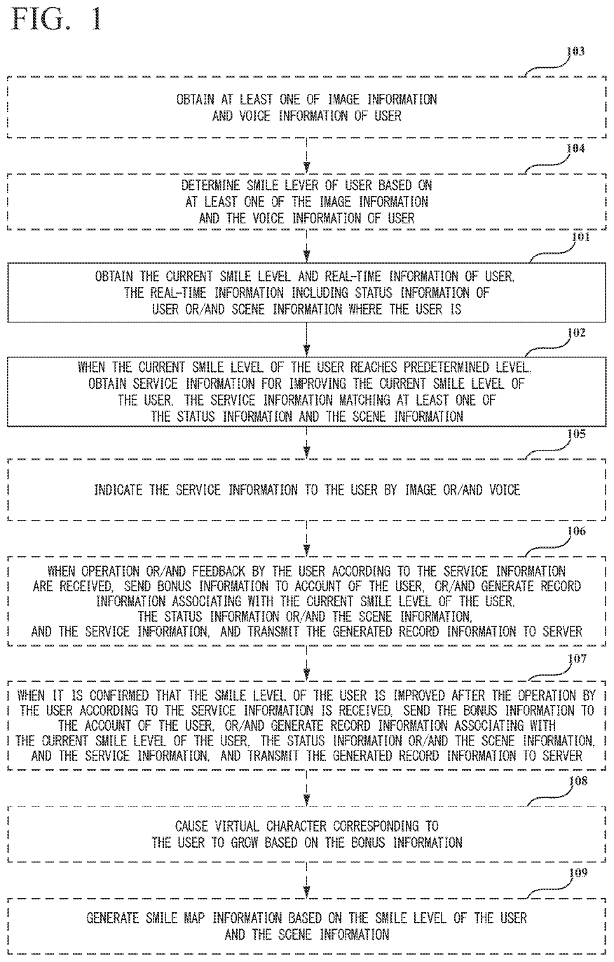

FIG. 1 is a schematic view showing an example of the information obtain method according to the first embodiment of the present disclosure. As shown in FIG. 1, the information obtain method includes a Step 101 of obtaining a current smile level of a user and a real-time information, wherein the real-time information includes a state information of the user and/or a scene information of a scene in which the user is; and a Step 102 of obtaining a service information when the smile level of the user reaches a predetermined level, wherein the service information matches at least one of the state information and the scene information while the service information is able to improve the current smile level of the user.

Accordingly, when the current smile level of the user reaches a predetermined level, the service information is pushed to the user. Accordingly, it is possible to push the service information to the user in a state in which it is possible for the user to receive the service information or the user intends to receive the service information so as to improve the user experience. Also, the service information pushed to the user is able to further improve the smile level of the user and the service information matches with the state information and/or the scene information such that it is possible to increase the happiness degree of the user and push the information capable of effectively improving the user experience to the user correctly.

In the present embodiment of the present disclosure, the terminal device may be various types of terminal devices. For example, the terminal device may be a mobile terminal device or an in-vehicle terminal device. Accordingly, the user of the terminal device may be the user of the mobile terminal device or the user of the in-vehicle device.

With respect to the in-vehicle device, the user is the user driving the vehicle and/or the user boarding on the vehicle.

In the present embodiment of the present disclosure, the number of the users may be at least one.

During the Step 101, the currently smile level of the user and the real-time information are obtained, and the real-time information includes the state information of the user and/or the scene information of the scene where the user is.

In the present embodiment, the smile level of the user can be detected by the terminal device in real time. For example, as shown in FIG. 1, the information obtain method may further include a Step 103 of obtaining at least one of the image information or the voice information of the user, and a Step 104 of determining the current smile level of the user based on at least one of the image information or the voice information of the user.

Accordingly, it is possible to correctly determine the smile level of the user in real time by determining the current smile level of the user based on at least one of the image information or the voice information of the user.

For example, with respect to the user of the mobile terminal device, the image information is obtained by the camera of the mobile terminal device in real time, and the voice information is obtained by the microphone of the mobile terminal device in real time. For example, with respect to the user of the in-vehicle terminal device, the image information is obtained by the camera attached inside the vehicle in real time, and the voice information is obtained by the microphone inside the vehicle in real time.

For example, the image information includes the image of the face of the user.

During the Step 104, the current smile level of the user is determined based on at least one of the image information and the voice information. For example, by identifying the face of the user included in the image information, it is possible to detect whether there is a smile existing on the face of the user and determine the level of the smile.

For example, by identifying the laughing voice included in the voice information, it is possible to detect whether there is a smile existing on the face of the user and determine the level of the smile.

The specific identification method can be referred to the relating well-known technologies. For example, it is possible to output the smile level and the reliability based on the identification model of the convolutional neural network. According to the embodiment of the present disclosure, the method for determining the smile level is not particularly limited.

According to the embodiment of the present disclosure, for example, the smile level can be shown by numbers.

For example, it is possible to categorize the smile level into level 0 to level 3 based on the presence or absence of the smile and the size of the smile. For example, in a case in which the smile level is zero, it means that there is no smile on the face, a case in which the smile level is 1 means a faint smile, a case in which the smile level is 2 means a normal smile, and a case in which the smile level is 3 means a great laughter. The specific method for categorizing the smile level can be determined corresponding to the actual situation, and it is not particularly limited according to the embodiment of the present disclosure.

According to Step 103 and Step 104, the current smile level of the user is determined.

The real-time information in Step 101 includes the state information of the user and/or the scene information of the scene where the user is. For example, this state information and the scene information can be obtained by the terminal device and/or other terminal device.

For example, the state information includes at least one of the fatigue information, the biometric information, and then exercise information of the user, and the scene information includes at least one of the environment information, the location information, the traffic information, and the weather information of an environment where the user is.

Accordingly, the state information and the scene information used for matching include various information such that it is possible to further improve the accuracy of the matching.

For example, the fatigue information can be obtained by analyzing the facial expression and the posture of the user, the biometric information can be obtained by a wearable device or a sensor provided in the sheet of the vehicle, and the exercise information can be obtained from an image of the body of the user, and by the wearable device or the sensor provided in the sheet of the vehicle.

For example, the scene information of the location where the user is may be an environment image obtained by imaging the surrounding environment of the vehicle by the camera of the mobile terminal device or the in-vehicle camera. The location information may be the information of the location where the user or the vehicle including the in-vehicle device is. The traffic information may be the traffic information around the vehicle that is obtained by the in-vehicle terminal device, for example, the traffic information may be the information regarding the congestion situation or the like. The weather information may be the weather information of the city or the region where the user is that is obtained by the mobile terminal device or the in-vehicle terminal device.

In Step 102, when the current smile level of the user reaches the predetermined level, the service information is obtained, wherein the service information is able to improve the current smile level of the user while the service information matches at least one of the state information or the scene information.

According to the present embodiment, this predetermined level can be determined due to the actual demand. For example, this predetermined level is “1”. Thus, the feature “reach the predetermined level” means that the current smile level of the user is equal to the predetermined level or higher than tan the predetermined level.

According to the present embodiment, the database for the matching can be stored in a server.

According to the present embodiment, the database is a pre-built database, and the database maybe updated at any time. In the database, various of service information are stored, and each service maybe stored in correspondence to the smile level, the state information, and the scene information.

In the present embodiment, for example, the service information for improving the current smile level of the user is the information of the service corresponding to a higher smile level than the current smile level of the user.

For example, in a case in which the current smile level of the user is “1”, since each service in the database is stored in correspondence with the smile level, the state information, and the scene information in the database, all of the services corresponding to the smile level “2” and “3” are searched in the database and then a service matching at least one of the state information or the scene information of the user is further sorted among these services such that it is possible to generate the service information, in other words, the information regarding the matching service. In the embodiment of the present disclosure, the service information may be the information of various services. For example, this service is the service of playing the multimedia information such as the music, radio, video, or other information in the multimedia format. For example, this service is the service of playing the product information, the merchant information, or the campaign information.

For example, the service for improving the current smile level of the user may be the services of playing gentle or hilarious music, playing funny stories, playing comics or talk shows, playing funny program radios, and playing activities in which the user is interested.

In the embodiment of the present disclosure, the service information may be generated by the server and then the generated information may be transferred to the terminal device, or the service information may be directly generated by the terminal device. Hereinafter, this feature will be described in details.

In the case in which the service information is generated by the server, at first, the terminal device monitors the smile level of the user in real time, and when the current smile level of the user reaches the predetermined level, the terminal device sends the current smile level of the user and the real-time information to the server. The server performs the matching by using the pre-built database, for example, the server matches the services that can improve the current smile level of the user in the database at first. In other words, for example, the server matches the services corresponding to the higher smile level than the current smile level of the user at first and further sorts at least one service by matching the real-time information among these services, and then the server generates and sends the information corresponding to the at least one service, that is, the service information, to the terminal device.

Otherwise, the service information may be directly generated by the terminal device. Firstly, the terminal device monitors the smile level of the user in real time, when the current smile level of the user reaches the predetermined level, the terminal device performs the matching in the pre-built database. For example, the terminal device matches the services that can improve the current smile level of the user in the database at first. In other words, for example, the terminal device matches the services corresponding to the higher smile level than the current smile level of the user at first and further sorts at least one service by matching the real-time information among these services, and then the terminal device generates the information corresponding to the at least one service, that is, the service information.

For example, in a case in which the real-time information includes the fatigue information of the user, the service information matching this fatigue information may be the service of playing gentle music. In a case in which the real-time information includes the location information, the service information matching the location information may be the service of playing the local news or stories.

In the embodiment of the present disclosure, the state information includes at least one first parameter indicating at least one of the fatigue information, the biometric information, and the exercise information, and the scene information includes at least one second parameter indicating at least one of the environment information, the location information, the traffic information, and the weather information.

For example, the first parameter is the parameter as at least one of the fatigue degree indicating the fatigue information, the heart rate indicating the biometric information, and the steps indicating the exercise information, and the second parameter is the parameter as at least one of the landscape density indicating the environment information, the congestion index indicating the traffic information, and the temperature and/or the air quality indicating the weather information.

When the service information is generated by the matching, the first parameter and the second parameter have their priorities, respectively. Accordingly, the effective information having a higher correspondence can be generated by the matching and then pushed to the user such that it is possible to provide the information more suitably fitting the current scene and the state.

For example, in a case in which it is set that the fatigue degree has the higher priority, when the service information is generated and pushed, it is considerable to provide the services that can effectively relieve fatigue and reduce the degree of fatigue in a high priority.

In the embodiment of the present disclosure, each service information can be stored in correspondence with the smile level, the first parameter and the second parameter.

In the embodiment of the present disclosure, as shown in FIG. 1, the information obtain method further includes the Step 105 of showing the service information to the user by the display manner and/or the voice manner. Accordingly, it is possible to push the information to the user more flexibly.

For example, the service information is shown to the user by the display of the terminal device, and/or the service information is played back to the user by the speaker of the terminal device.

In the embodiment of the present disclosure, as shown in FIG. 1, the information obtain method further includes the Step 106 of sending a bonus information to an account of the user when an operation based on the service information and/or a feedback from the user is received, and/or generating a record information by associating the current smile level of the user, the state information and/or the scene information, and the service information, and sending the record information to the server.

In the embodiment of the present disclosure, the operation from the user based on the service information refers to the operation performed by the user that is necessary for the service after the user receives the service information pushed to the user, for example, the operation of playing back the music indicated by the pushed service information.

In the embodiment of the present disclosure, the feedback from the user based on the service information refers to the feedback opinion or comment of the user with respect to the service or the service information.

In the embodiment of the present disclosure, by sending the bonus information to the account of the user when the operation based on the service information and/or a feedback from the user is received, it is possible to encourage the user to use and experience the service information so as to further improve the user experience.

For example, the bonus information may be the user point.

In the embodiment of the present disclosure, when the operation based on the service information and/or a feedback from the user is received, the record information is generated. This record information is the information stored by associating the current smile level of the user, the state information and/or the scene information, and the service information, and the record information can be used to update the database. Accordingly, the information with values are stored and the database used for the matching can be updated so as to improve the accuracy of the matching.

For example, with regard to the service that is accepted by the user, at the next time of pushing the information to the user, it is preferable to push this service or the similar information to the user in priority.

In the embodiment of the present disclosure, as shown in FIG. 1, the information obtain method further includes the Step 107 of sending a bonus information to an account of the user in a case in which the smile level of the user is detected to be improved after the operation based on the service information from the user is received, and/or generating a record information by associating the current smile level of the user, the state information and/or the scene information, and the service information, and sending the record information to the server.

Accordingly, it is possible to further encourage the user to use and experience the service information and improve the user experience. Also, in this situation, by generating the record information and sending the generated record information to the server, it is possible to record the information with values for the later usage and update the database for the matching so as to improve the accuracy of the matching.

For example, in a case in which the user accepts the service of improving the smile level of the user and the smile level of the user is actually improved, at the next time of pushing the information to the user, it is preferable to push this service or the similar information to the user in priority.

In the embodiment of the present disclosure, as shown in FIG. 1, the information obtain method further includes a Step 108 of making a virtual character corresponding to the user to grow based on the bonus information.

Accordingly, it is possible to build a firm correspondence relationship between the change of the virtual character and the user. Accordingly to such a correspondence relationship, by encouraging the user to smile for prompting the growth of the virtual character, it is possible to keep the user in the positive mood and further improve the user experience.

In the embodiment of the present disclosure, the growth of the virtual character may include at least one of the image change of the character, the increase of the movements of the character, and the increase of the number of the characters.

In the embodiment of the present disclosure, the image change of the character includes the change of the age and the appearance, the change in the skin color, the change of the clothing, the change of the proportion and the like.

In the embodiment of the present disclosure, the increasing of the movements of the character includes the examples of performing the jumping movements, performing roll movements, making funny faces, waving hands and the like.

In the embodiment of the present disclosure, the increasing of the number of the characters means that the quantity of the virtual characters corresponding to the user can be increased from the initial one character to two or more characters.

When the virtual characters are increased to at least two, the at least two virtual characters may have a predetermined relationship therebetween, and the at least two virtual characters may perform interactions corresponding to the predetermined relationship.

Accordingly, it is possible to increase the fun of the characters and further improve the user experience.

For example, the virtual characters corresponding to the user are increased to two, and the at least two virtual characters build family member relationships.

Then, the interaction corresponding to the predetermined relationship may be set in advance.

In the embodiment of the present disclosure, the virtual characters and the change thereof may be displayed in the terminal device, for example, in the in-vehicle terminal.

In the embodiment of the present disclosure, as shown in FIG. 1, the information obtain method may include a Step 109 of generating a smile map information based on the smile level of the user and the scene information. Accordingly, it is possible to provide the user with the information having enriched fun and further improve the user experience.

In the embodiment of the present invention, for example, the smile map information is generated by combining the scene information at the time when the smile level is larger than the predetermined value and the map information. At the time of generating the smile map information, it is possible to generate the smile map having a higher correspondence in consideration of the factors such as the friends of the user, the regional range and the like.

In the embodiment of the present disclosure, the above-described Step 103 to Step 109 are selectable steps.

According to the above-described examples, the matching is performed based on the state information of the user and/or the scene information of the location where the user is, and in the embodiment of the present disclosure, the service information may be generated by combining the user information of the user to perform the matching.

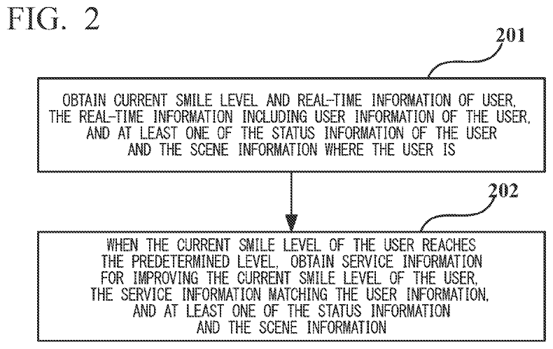

FIG. 2 is a schematic view showing another example of the information obtain method according to the first embodiment of the present disclosure. As shown in FIG. 2, the information obtain method includes the Step 201 of obtaining the current smile level of the user and the real-time information, wherein the real-time information includes at least one of the state information of the user and the scene information of the scene in which the user is and the user information of the user, and the Step 202 of obtaining the service information when the smile level of the user reaches the predetermined level, wherein the service information matching the user information of the user and at least one of the state information and the scene information while the service information is able to improve the current smile level of the user.

In the embodiment of the present disclosure, the user information may have at least one third parameter indicating at least one of the identification (ID) information, the hobby information, and the usage history information of the user.

In the present embodiment, at the time of generating the service information by the matching, the first parameter, the second parameter, and the third parameter have priorities respectively.

Accordingly, by combining the user information to perform the matching, it is possible to generate and push the effective information having a higher correspondence by the matching so as to further improve the accuracy of the information push.

In FIG. 2, other steps except for Step 101 and Step 102 may be included therein. The specific configurations can be referred to the above disclosure and the description is omitted.

Hereinafter, a case in which there are at least two users will be described.

In the embodiment of the present disclosure, the at least two users are in the same scene. For example, the at least two users are the user driving the vehicle and the user boarding on the vehicle.

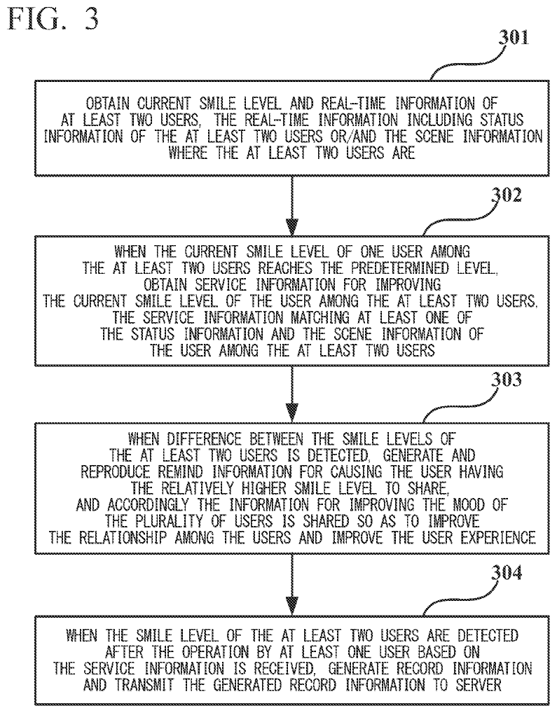

FIG. 3 is a schematic view showing a further example of the information obtain method according to the first embodiment of the present disclosure. As shown in FIG. 3, the information obtain method includes the Step 301 of obtaining the current smile levels of the at least two users and the real-time information, wherein the real-time information are the state information of the at least two users and the scene information of the scene where the at least two users are, and the Step 302 of obtaining the service information in a case in which the current smile level of at least one of the two users reaches the predetermined level, wherein the service information is able to improve the current smile level of at least one of the two users, and the service information matches at least one of the state information or the scene information of the at least one of the two users.

Accordingly, it is possible to appropriately push the information in the scene having multiple users therein.

In the embodiment of the present disclosure, as shown in FIG. 3, the information obtain method may further include the Step 303 of generating and broadcasting the remind information with respect to the user having the higher smile level so as to encourage a sharing by the user in the case in which the difference between the smile levels of the at least two users reaches the predetermined value.

In the embodiment of the present disclosure, the predetermined value may be determined due to the actual demand.

In the embodiment of the present disclosure, as shown in FIG. 3, the information obtain method may further include the Step 304 of generating the record information and sending the record information to the server in a case in which it is detected that both the smile levels of the at least two users are improved after the operation based on the service information from the at least one user is received.

The record information may be used for updating the database. Accordingly, it is possible to record the information having values and update the database for the matching so as to improve the accuracy of the matching.

For example, with regard to the service of improving both the smile levels of the at least two users, at the time of pushing the information to the at least two users, it is possible to push the service or the similar service in priority.

In the embodiment of the present embodiment, the executing sequence of the Step 303 with respect to the Step 302 and the Step 304 is not limited. In other words, the Step 303 may be a step independent from the Step 302 and the Step 304.

According to the above-described embodiment, when the current smile level of the user reaches the predetermined level, the service information is pushed to the user. Accordingly, it is possible to push the service information to the user in the state in which it is possible for the user to receive the service information or the user intends to receive the service information to improve the user experience. The service information being pushed to the user can improve the current smile level of the user while the service information matches with the state information and/or the scene information such that it is possible to increase the happiness degree of the user and definitely push the information for effectively improving the user experience to the user.

Furthermore, at the time of generating the service information, it is possible to further improve the accuracy of pushing the information by performing the matching by combining the user information.

The state information and the scene information being used for the matching include various of information so as to further improve the accuracy of the matching.

Furthermore, at the time of generating the service information via the matching, the first parameter of the state information, the second parameter of the scene information, and the third parameter of the user information have priorities respectively. Accordingly, it is possible to generate and push the effective information with higher correspondence by the matching so as to fit with the current scene and the state.

It is possible to correctly determine the smile level of the user in real-time by determining the current smile level of the user based on at least one of the image information and the voice information of the user.

It is possible to push the information to the user flexibly by showing the service information to the user by the display manner and/or the voice manner.

Furthermore, by sending the bonus information to the account of the user when the operation and/or the feedback based on the service information is received from the user, it is possible to encourage the user to use or experience the service information so as to further improve the user experience. In this situation, by generating the record information and sending the record information to the server, it is possible to record the information with values and update the database for the matching so as to further improve the accuracy of the matching.

In the case in which the smile level of the user is detected to be improved after the operation based on the service information is received from the user, the bonus information is sent to the account of the user. Accordingly, it is possible to encourage the user to use or experience the service information so as to further improve the user experience. In this situation, by generating the record information and sending the record information to the server, it is possible to record the information with values for the later usage and update the database for the matching so as to further improve the accuracy of the matching.

By making the virtual character corresponding to the user to grow based on the bonus information, it is possible to build a firm correspondence relationship between the virtual character and the user. According to such a correspondence relationship, it is possible to encourage the user to smile for prompting the growth of the virtual character such that it is possible to keep the user in the positive mood and further improve the user experience.

The growth of the virtual character may include at least one of the image change of the virtual character, the increase of the movements of the virtual character, and the increase of the number of the virtual characters. The image change of the virtual character can enrich the visual experience of the user, the increase of the movements of the virtual character can increase the functions that can be used by the user, and the increase of the number of the virtual characters can significantly increase the fun of the user when using the devices so as to further improve the user experience.

In a case in which there are at least two virtual characters, there is a specific relationship between the at least two virtual characters and the at least two virtual characters perform the interaction corresponding to the specific relationship. Accordingly, it is possible to further increase the fun of using the virtual character and improve the user experience.

In a case in which it is detected that the difference between the smile levels of the at least two users reaches the predetermined value, by generating and broadcasting the remind information with respect to the user having the higher smile level, it is possible to share the information about mood improvement among multiple users and ease relationships between the users so as to further improve the user experience.

Furthermore, when the smile level of at least one of the two users reaches the predetermined value, it is possible to push information appropriately in the scene of multiple users by obtaining the service information.

In a case in which it is detected that both the smile levels of the at least two users are improved after the operation based on the service information from the at least one user is received, the record information is generated and sent to the server. Accordingly, in the scene in which there are multiple users, it is possible to record the information with values for the later usage and update the database for the matching so as to further improve the accuracy of the matching.

Furthermore, the service information being able to improve the current smile level of the user is the information of the service corresponding to the higher smile level than the current smile level of the user. Accordingly, it is possible to easily realize the matching of the services and ensure the effectiveness of the service obtained by the matching for improving the smile level. Furthermore, by generating the smile map information based on the smile level of the user and the scene information, it is possible to provide the information with enough fun to the user to further improve the user experience.

### Second Embodiment

A second embodiment of the present disclosure provides an information push method, and the information push method can be implemented in a server. In the case in which the service information is generated by the server according to the first embodiment, the information push method according to the second embodiment corresponds to the information obtain method according to the first embodiment.

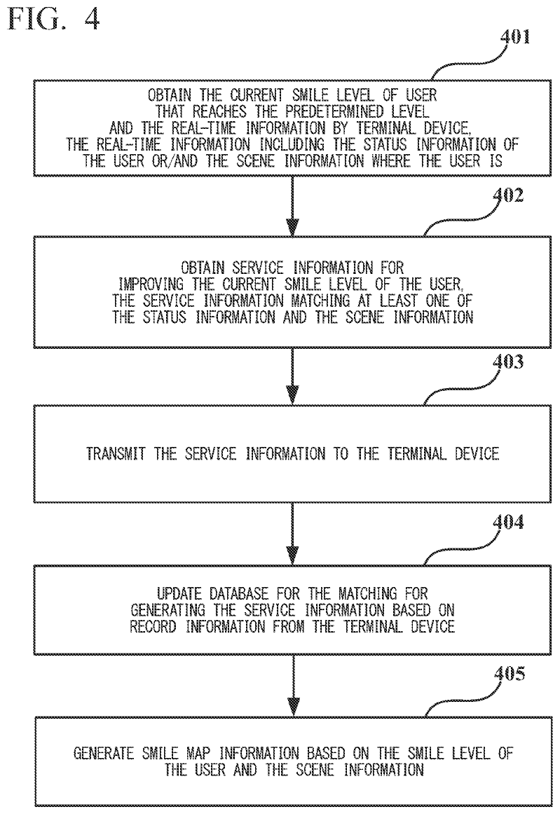

FIG. 4 is a schematic view showing an information push method according to the second embodiment of the present disclosure. As shown in FIG. 4, the information push method includes a step 401 of obtaining a current smile level of a user that reaches a predetermined level and a real-time information from a terminal device, wherein the real-time information includes a state information of the user and/or a scene information of a scene in which the user is; a step 402 of generating a service information, wherein the service information is able to improve the current smile level of the user while the service information matches at least one of the state information and the scene information; and a step 403 of sending the service information to the terminal device.

In the embodiment of the present disclosure, when the terminal device detects that the smile level of the user reaches the predetermined level, the terminal device sends the smile level reaching the predetermined level and the real-time information to the server.

In the embodiment of the present disclosure, for example, the service information being able to improve the current smile level of the user is the information of the service corresponding to the higher smile level than the current smile level of the user.

In the embodiment of the present disclosure, the specific method of generating the service information by the server can be referred to the disclosure of the first embodiment, and the duplicate descriptions are omitted.

Also, when the service information is generated by the server, it is possible to perform the matching in consideration of the user information. The specific method can be referred to the disclosure of the first embodiment, and the duplicate descriptions are omitted.

In the embodiment of the present disclosure, as shown in FIG. 4, the information push method may include a step of updating the database used in the matching for generating the service information based on the record information from the terminal device.

For example, the record information is generated after the terminal device receives the operations and/or feedback comments based on the service information from the user, and/or the record information is generated when the smile level of the user is improved after the terminal device receives the operations based on the service information from the user.

For example, the record information may be the information stored by associating the current smile level of the user and the scene information. The record information is used at the time of updating the database. Accordingly, it is possible to record the information having values and it is possible to update the database for the matching so as to improve the accuracy of the matching.

In the embodiment of the present disclosure, as shown in FIG. 4, the information push method may include a step 405 of generating the smile map information based on the smile level of the user and the scene information.

In other words, the smile map may be generated by the server.

Accordingly, it is possible to provide the user with the information having a lot of fun so as to improve the user experience.

In the embodiment of the present disclosure, for example, the scene information where the smile level is larger than the predetermined value and the map information are combined to generate the smile map information. Then at the time of generating the smile map information, it is possible to generate the smile map with a higher correspondence in consideration of the friends of the user and the regional range.

According to the above-described embodiment, when the current smile level of the user reaches the predetermined level, the service information is pushed to the user. Accordingly, it is possible to push the service information to the user in the state in which it is possible for the user to receive the service information or the user intends to receive the service information to improve the user experience. The service information being pushed to the user can improve the current smile level of the user while the service information matches with the state information and/or the scene information such that it is possible to increase the happiness degree of the user and definitely push the information for effectively improving the user experience to the user.

### Third Embodiment

A third embodiment of the present disclosure provides an information push method, and the information push method are applied in the terminal device and the server. The present information push method corresponds to the information obtain method according to the first embodiment and the information push method according to the second embodiment.

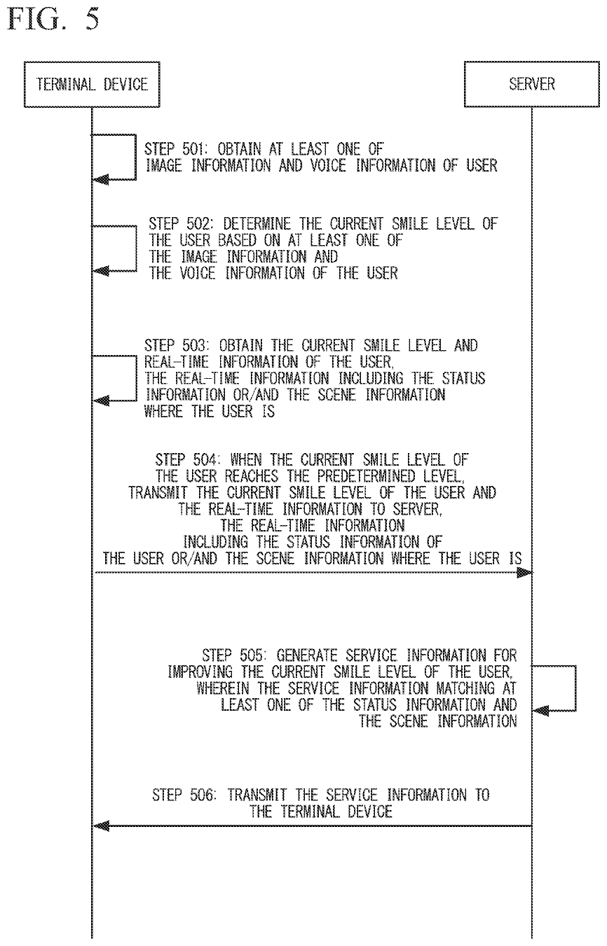

FIG. 5 is a flowchart of the information push method according to the third embodiment of the present disclosure. As shown in FIG. 5, the information push method includes a Step 501 of obtaining at least one of the image information or the voice information of the user, a Step 502 of determining the current smile level of the user based on at least one of the image information or the voice information of the user, a Step 503 of obtaining the current smile level of the user and the real-time information, wherein the real-time information includes the state information of the user and/or the scene information of the scene where the user is, a Step 504 of sending the current smile level and the real-time information to the server when the current smile level of the user reaches the predetermined level, wherein the real-time information includes the state information of the user and/or the scene information of the scene where the user is, a Step 505 of generating the service information which is able to improve the current smile level of the user and the service information matches at least one of the state information or the scene information, and a Step 506 of sending the service information to the terminal device.

In the embodiment of the present disclosure, the service information that is able to improve the current smile level of the user is the information of the service corresponding to a higher smile level than the current smile level of the user.

In the embodiment of the present disclosure, the specific method of each step described above can refer to the disclosure in the first embodiment and the second embodiment and the duplicate disclosure is omitted.

According to the above-described embodiment, when the current smile level of the user reaches the predetermined level, the service information is pushed to the user. Accordingly, it is possible to push the service information to the user in the state in which it is possible for the user to receive the service information or the user intends to receive the service information to improve the user experience. The service information being pushed to the user can improve the current smile level of the user while the service information matches with the state information and/or the scene information such that it is possible to increase the happiness degree of the user and definitely push the information for effectively improving the user experience to the user.

### Fourth Embodiment

A fourth embodiment of the present disclosure provides a terminal device, wherein the terminal device is configured to implement the information obtain method according to the first embodiment. The functions of the terminal device can refer to the disclosure of the first embodiment, and the duplicate disclosure is omitted.

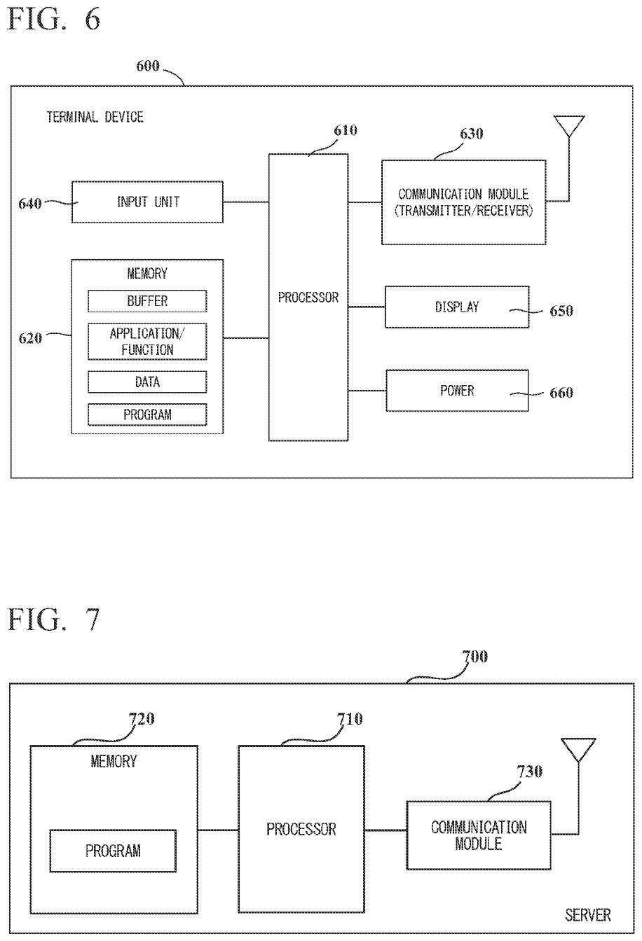

FIG. 6 is a schematic view showing a system configuration of the terminal device according to the fourth embodiment of the present disclosure. As shown in FIG. 6, the terminal device 600 may include a processor 610 and a memory 620. The memory 620 is coupled with the processor 610. It should be noted that the configuration shown in FIG. 6 is only an example, and other configurations can be adopted to replenish or replace the present configuration so as to implement the communication function or other functions.

According to an example, the processor 610 obtains the current smile level of the user and the real-time information, and the real-time information includes at least one of the state information of the user and the scene information of the scene where the user is, and when the current smile level of the user reaches the predetermined level, the processor 610 obtains the service information, wherein the service information is able to improve the current smile level of the user and matches at least one of the state information and the scene information.

As shown in FIG. 6, the terminal device 600 may further includes a communication module 630, an input unit 640, a display 650, and a power unit 660. It should be noted that it is not necessary for the terminal device 600 to include the all configurations shown in FIG. 6. The terminal device 600 may be configured to include other configurations that are not shown in FIG. 6 by referring to the related technology.

As shown in FIG. 6, the processor 610 may be referred to as a controller or an operation control unit. The processor 610 may include a microprocessor, or other processor device and or logical device. The processor 610 is configured to receive the input and control the operations of each configuration of the terminal device 600.

The memory 620 may be, for example, one or multiple configurations selected from a buffer, a flash memory, a hard disk, a removable medium, a volatile memory, a non-volatile memory, and other suitable devices. The memory 620 is configured to store the data and is able to store and execute the program of the corresponding information. The processor 610 can perform the storage and processing of the information by executing the program stored in the memory 620. The functions of other configurations are similar to the conventional technology and the specific description is omitted. Each configuration of the terminal device 600 can be implemented using the dedicated hardware, firmware, software, and combinations thereof without departing from the scope of the present disclosure.

According to the above-described embodiment, when the current smile level of the user reaches the predetermined level, the service information is pushed to the user. Accordingly, it is possible to push the service information to the user in the state in which it is possible for the user to receive the service information or the user intends to receive the service information to improve the user experience. The service information being pushed to the user can improve the current smile level of the user while the service information matches with the state information and/or the scene information such that it is possible to increase the happiness degree of the user and definitely push the information for effectively improving the user experience to the user.

### Fifth Embodiment

A fifth embodiment of the present disclosure provides a server. The server is configured to execute the information push method according to the second embodiment. The functions of the server can refer to the disclosure of the second embodiment and the duplicate description is omitted.

FIG. 7 is a schematic view showing a system configuration of the server according to the fifth embodiment of the present disclosure. As shown in FIG. 7, the server 700 may include a processor 710 and a memory 720. The memory 720 is coupled with the processor 710. It should be noted that the configuration shown in FIG. 7 is only an example, and other configurations can be adopted to replenish or replace the present configuration so as to implement the communication function or other functions.

According to an example, the processor 710 is configured to obtain the current smile level of the user and the real-time information from the terminal device 600, and the real-time information includes at least one of the state information of the user and the scene information of the scene where the user is, and when the current smile level of the user reaches the predetermined level, the processor 710 generates the service information, wherein the service information is able to improve the current smile level of the user and matches at least one of the state information and the scene information and send the service information to the terminal device 600.

As shown in FIG. 7, the server 700 may further includes a communication module 730. It should be noted that it is not necessary for the server 700 to include the all configurations shown in FIG. 7. The server 700 may be configured to include other configurations that are not shown in FIG. 7 by referring to the related technology.

As shown in FIG. 7, the processor 710 may be referred to as a controller or an operation control unit. The processor 610 may include a microprocessor, or other processor device and or logical device. The processor 710 is configured to receive the input and control the operations of each configuration of the terminal device 700.

The memory 720 may be, for example, one or multiple configurations selected from a buffer, a flash memory, a hard disk, a removable medium, a volatile memory, a non-volatile memory, and other suitable devices. The memory 720 is configured to store the data and is able to store and execute the program of the corresponding information. The processor 710 can perform the storage and processing of the information by executing the program stored in the memory 720. The functions of other configurations are similar to the conventional technology and the specific description is omitted. Each configuration of the terminal device 700 can be implemented using the dedicated hardware, firmware, software, and combinations thereof without departing from the scope of the present disclosure.

According to the above-described embodiment, when the current smile level of the user reaches the predetermined level, the service information is pushed to the user. Accordingly, it is possible to push the service information to the user in the state in which it is possible for the user to receive the service information or the user intends to receive the service information to improve the user experience. The service information being pushed to the user can improve the current smile level of the user while the service information matches with the state information and/or the scene information such that it is possible to increase the happiness degree of the user and definitely push the information for effectively improving the user experience to the user.

### Sixth Embodiment

A sixth embodiment of the present disclosure provides an information push system. The information push system includes the terminal device according to the fourth embodiment and the server according to the fifth embodiment. The functions of the terminal device and the server can refer to the disclosure of the fourth embodiment and the fifth embodiment and the duplicate description is omitted.

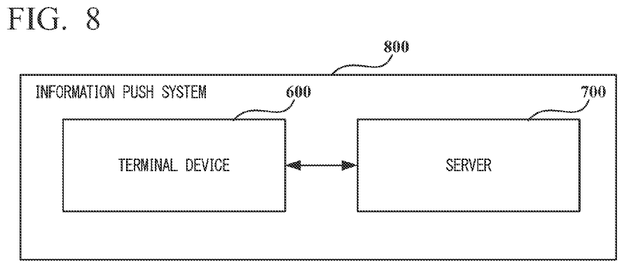

FIG. 8 is a schematic view showing the information push system according to the sixth embodiment. As shown in FIG. 8, the information push system 800 includes the terminal device 600 and the server 700, and the specific configurations can refer to the disclosure according to the fourth embodiment and the fifth embodiment.

For example, the terminal device 600 is the in-vehicle terminal device and the in-vehicle device detects the smile level of the user boarding on the vehicle by the in-vehicle camera and the in-vehicle microphone.

When the current smile level of the user is detected to reach the predetermined level, for example, when the smile level is “1”, the in-vehicle terminal device sends the current smile level “1” and the current real-time, for example, the information regarding the fatigue degree and the congestion to the server 700.

The server 700 performs the matching in the database. Firstly, the server 700 selects the services that are possible to improve the smile level of the user by matching the services with the higher smile level than the current smile level of the user, for example, the services having the smile level “2” or the smile level “3”.

The server 700 further selects at least one service from those services obtained by the matching to match the real-time information, that is, at least one of the fatigue degree and the congestion situation. For example, the at least one service obtained by the matching is to play the music of a song A and play the radio B. Accordingly, the server 700 generates the information relating the playback of the music of the song A and playing the radio B as the service information and sends the service information to the in-vehicle terminal device so as to push the information to the driver as the user. The driver receives the pushed information from the operations to the in-vehicle terminal device and then the bonus information, for example, the point bonus to the account of the driver in the in-vehicle terminal device. In the in-vehicle terminal device, it is possible to store the information of the virtual character therein and it is possible to show the virtual character. When the points are saved to some degree, it is possible to control the growth of the virtual character, for example, to make the virtual character to grow up, change the clothing, or increase the quantity of the virtual characters.

According to the above-described embodiment, when the current smile level of the user reaches the predetermined level, the service information is pushed to the user. Accordingly, it is possible to push the service information to the user in the state in which it is possible for the user to receive the service information or the user intends to receive the service information to improve the user experience. The service information being pushed to the user can improve the current smile level of the user while the service information matches with the state information and/or the scene information such that it is possible to increase the happiness degree of the user and definitely push the information for effectively improving the user experience to the user.

Although the respective embodiments and modifications of the present disclosure have been described above, the technical scope of the present disclosure is not limited to the above-described embodiments, and configurations in the respective embodiments and modifications within the scope not departing from the spirit of the present disclosure. It is possible to change the combination of elements, make various changes to each configuration element, or delete each configuration element. The present disclosure is not limited by the above description, and is only limited by the appended claims.

What is claimed is:

1. An information obtain method, comprising:
a step of obtaining a current smile level of a user and a real-time information, the real-time information including a state information of the user and/or a scene information of a scene in which the user is; and
a step of obtaining a service information when the smile level of the user reaches a predetermined level, the service information matching at least one of the state information and the scene information while the service information being able to improve the current smile level of the user.

2. The information obtain method according to claim 1, wherein the service information being able to improve the currently smile level of the user is information of a service corresponding to a higher smile level than the current smile level of the user.

3. The information obtain method according to claim 1, further comprises a step of obtaining an user information of the user,
wherein the service information is able to improve the current smile level of the user while matching the user information and at least one of the state information and the scene information.

4. The information obtain method according to claim 3,
wherein the state information includes at least one of a fatigue information, a biometric information, and an exercise information of the user,
the scene information includes at least one of an environment information, a location information, a traffic information, and a weather information of an environment where the user is, and
the user information includes at least one of an identification (ID) information, a hobby information, and an usage history information of the user.

5. The information obtain method according to claim 4,
wherein the state information includes at least a first parameter indicating at least one of the fatigue information, the biometric information, and the exercise information of the user,
the scene information includes at least a second parameter indicating at least one of the environment information, the location information, the traffic information, and the weather information of the environment where the user is,
the user information includes at least a third parameter indicating at least one of the identification (ID) information, the hobby information, and the usage history information of the user, and
each of the first parameter, the second parameter, and the third parameter has a priority at the time of performing the matching for generating the service information.

6. The information obtain method according to claim 1, further comprises:
a step of obtaining at least one of an image information or a voice information of the user; and
a step of determining the current smile level of the user based on at least one of the image information or the voice information of the user.

7. The information obtain method according to claim 1, further comprises a step of showing the service information to the user by a display manner and/or a voice manner.

8. The information obtain method according to claim 1, further comprises:
a step of sending a bonus information to an account of the user when an operation based on the service information and/or a feedback from the user is received, and
a step of generating a record information by associating the current smile level of the user, the state information and/or the scene information, and the service information, and sending the record information to a server.

9. The information obtain method according to claim 7, further comprises:
a step of sending a bonus information to an account of the user in a case in which the smile level of the user is detected to be improved after an operation based on the service information from the user is received, and
a step of generating a record information by associating the current smile level of the user, the state information and/or the scene information, and the service information, and sending the record information to a server.

10. The information obtain method according to claim 8, further comprises a step of making a virtual character corresponding to the user to grow based on the bonus information.

11. The information obtain method according to claim 1,
wherein there are at least two users, and
the information obtain method further comprises a step of generating and broadcasting a remind information with respect to the user having the higher smile level so as to encourage a sharing by the user in a case in which a difference between the smile levels of the at least two users reaches a predetermined value.

12. The information obtain method according to claim 1,
wherein there are at least two users, and
the information obtain method further comprises a step of obtaining the service information in a case in which the current smile level of at least one of the two users reaches a predetermined level, the service information being able to improve the current smile level of at least one of the two users, and the service information matching at least one of the state information or the scene information of the at least one of the two users.

13. The information obtain method according to claim 12, further comprises a step of generating a record information by associating the current smile level of the at least two users, the state information and/or the scene information, and the service information, and sending the record information to a server in a case in which it is detected that both the smile levels of the at least two users are improved after the operation based on the service information from the at least one user is received.

14. The information obtain method according to claim 1, further comprises a step of generating a smile map information based on the smile level of the user and the scene information.

15. An information push method, comprises:
a step of obtaining a current smile level of a user that reaches a predetermined level and a real-time information from a terminal device, the real-time information including a state information of the user and/or a scene information of a scene in which the user is;
a step of generating a service information, the service information being able to improve the current smile level of the user while the service information matching at least one of the state information and the scene information; and
a step of sending the service information to the terminal device.

16. The information push method according to claim 15, further comprises a step of updating a database for the matching to generate the service information based on a record information of the terminal device, wherein the record information is information generated by associating the current smile level of the user, the state information and/or the scene information, and the service information and stored.

17. The information push method according to claim 15, wherein the service information being able to improve the current smile level of the user is information of a service corresponding to a higher smile level than the current smile level of the user.

18. A terminal device, comprising:
a memory storing a computer-readable program; and
a processor configured to implement the information obtain method according to claim 1 when the computer-readable program is executed by the processor.

19. The terminal device according to claim 18, wherein the terminal device is an in-vehicle terminal, and the user is the user driving the vehicle, and/or a user boarding on the vehicle.
